(19) United States
(12) Patent Application Publication
(10) Pub. No.: US 2009/0205720 A1
(43) Pub. Date: Aug. 20, 2009

(54) Burst Disc Replacement Apparatus

(75) Inventors: Matthew HOBBS, Oxford (GB); Trevor Bryan Husband, Oxon (GB); Philip Alan Charles Walton, Oxon (GB)

Correspondence Address: CROWELL & MORING LLP;INTELLECTUAL PROPERTY GROUP, P.O. BOX 14300, WASHINGTON, DC, 20044-4300, US

(73) Assignee: Siemens Magnet Technology Ltd., Oxon (GB)

(21) Appl. No.: 12/353,763

(22) Filed: Jan. 14, 2009

(30) Foreign Application Priority Data
Feb. 15, 2008 (GB) 0802804.5
Aug. 8, 2008 (GB) 0814531.0

(51) Int. Cl. F16K 43/00; F16K 17/16; F17C 3/02

(52) U.S. Cl. 137/329.1; 137/68.23; 62/51.1

(57) ABSTRACT

A burst disc replacement apparatus (102) comprises a magazine (114) carrying a first burst disc (116) and a second burst disc (118). The apparatus also comprises a flow path (104) therethrough for venting fluid. The first burst disc (116) is located in the flow path (104) and the second burst disc (118) is located outside the flow path (104). A translation mechanism is also provided and coupled to the magazine (114) and arranged to permit manual translation of the magazine (114) so that the second burst disc (118) moves, when in use, into the flow path (104) in place of the first burst disc (116).

The present invention relates to a burst disc replacement apparatus of the type that, for example, is used to provide relief from excessive pressure build-up in respect of cryogen vented from a superconducting magnet unit.

In the field of nuclear Magnetic Resonance Imaging (MRI), a magnetic resonance imaging system typically comprises a superconducting magnet, gradient and field coils, shim coils and a patient table. The superconducting magnet is provided in order to generate a strong uniform static magnetic field, known as the B₀ field, in order to polarise nuclear spins in an object under test.

Presently, the coils forming the superconducting magnet are made from metals that exhibit the property of superconduction at very low temperatures. To achieve superconduction, the superconducting magnet is therefore cooled to the very low temperatures. One known cryogen-cooled superconducting magnet unit includes a cryostat including a cryogen vessel. A cooled superconducting magnet is provided within the cryogen vessel, the cryogen vessels being retained within an outer vacuum chamber (OVC). One or more thermal radiation shields are provided in a vacuum space between the cryogen vessel and the OVC. In some known arrangements, a refrigerator is mounted in a refrigerator sock located in the cryostat, the refrigerator being provided for the purpose of maintaining the temperature of a cryogen provided in the cryogen vessel. The refrigerator also serves sometimes to cool one or more of the radiation shields. The refrigerator can be a two-stage refrigerator, a first cooling stage being thermally linked to the radiation shield in order to provide cooling to a first temperature, typically in the region of 50-80K. A second cooling stage provides cooling of the cryogen gas to a much lower temperature, typically in the region of 4-10K.

As a result of a number of different factors, the cryogen used can become heated, for example from heating of the cryogen vessel or so-called “quenching” of superconducting wire from which the coils are formed, and hence so-called “boil-off” of the cryogen used can occur. When boil-off occurs, the pressure of the cryogen in the superconducting magnet unit, for example helium, must be limited and so pressure-release mechanisms are known typically employing a combination of valves and burst discs. Burst discs, or rupture discs as they are sometimes known, are discs having a membrane of material that serve as a barrier to fluids up to a specified pressure limit, but which break upon the specified pressure being exceeded, thereby allowing the fluid to pass therethrough. However, in respect of a superconducting magnet unit, once a burst disc has ruptured due to excessive pressure, the cryogen vessel is exposed to atmosphere, consequently risking air ingress. A service engineer must also be called in order to replace the damaged burst disc.

US patent publication no. 2005/198973 A1 relates to a burst disc configuration comprising a pair of burst discs in parallel, a first flow path coupled to a cryogen vessel extending to a first burst disc and a second flow path optionally coupleable to the cryogen vessel extending to a second burst disc. Initially, gas flow is via the first flow path to the first burst disc. When the first burst disc ruptures, the gas flow is diverted via the second flow path to the second, unperforated, burst disc. However, in order for the redirection of the gas flow to take place, a service engineer has to be notified and to attend the superconducting magnet unit in order to effect the diversion. In this respect, this type of pressure-release mechanism typically requires a valve to be provided for each of the two flow paths, the service engineer closing the valve corresponding to a spent burst disc and then opening the valve corresponding to the remaining, unspent, burst disc. Once the diversion has been implemented, the service engineer can replace the spent burst disc. Furthermore, the configuration described above has additional potential leak paths due to a need for an increased number of joints.

An alternative solution, as described in US patent publication no. 2005/088266 A1, is to provide a so-called quench valve, typically also fitted with a burst disc, as such valves are susceptible to failure by freezing from venting cold gas. The quench valve is capable of resealing itself after venting fluid due to a slight pressure increase. However, if the burst disc inside the quench valve ruptures owing to the valve failing to open, a service engineer also has to attend the superconducting magnet unit in order to replace the ruptured burst disc, particularly but not exclusively due to the complicated nature of the structure of the quench valve. The superconducting magnet-unit therefore becomes unusable until the burst disc is replaced. Such valve arrangements are also prone to allowing air ingress if the quench valve fails to reseal correctly.

U.S. Pat. No. 6,109,042 and US 2003/127132 A1 disclose burst disc-related measures to vent cryogen using a burst disc. However, in common with the above-described techniques, these documents describe measures that require replacement of the burst disc by a service engineer following rupture of the burst disc. As will be appreciated, the need for a service engineer to attend a site where the superconducting magnet unit is deployed can be costly and can result in operators refraining from using the superconducting magnet unit until the service engineer replaces the broken burst disc. Furthermore, as mentioned above, whilst the service engineer is awaited, the cryogen vessel is exposed to the possibility of air ingress.

According to first aspect of the present invention, there is provided a burst disc replacement apparatus comprising: a magazine carrying a first burst disc and a second burst disc; a flow path therethrough for venting fluid, the first burst disc being located in the flow path and the second burst disc being located outside the flow path; and a translation mechanism coupled to the magazine and arranged to permit manual translation of the magazine so that the second burst disc moves, when in use, into the flow path in place of the first burst disc.

The magazine may be arranged to carry a plurality of burst discs including the first burst disc and the second burst disc.

The magazine may be pivotally mounted. Alternatively, the magazine may be arranged to translate linearly.

The first burst disc and the second burst disc may follow an arcuate translation path.

The magazine may be arranged to translate so as to follow a substantially straight line.

The magazine may be arranged to reciprocate at least between a first position and a second position.

The apparatus may further comprise a mechanical stop for prevention of misalignment of the second burst disc with the flow path.

The magazine may define a substantially sector-shaped planar carrier.

The magazine may define a substantially rectangular-shaped carrier.

The carrier may be arranged to receive a replacement burst disc in place of the first burst disc or the second burst disc.

The carrier may be arranged to retain replaceably the first burst disc and/or the second burst disc.

The apparatus may further comprise: an inlet port disposed on one side of the magazine; and a biasing device arranged to urge the magazine towards the inlet port.

The apparatus may further comprise: a first surface and a second surface arranged to cooperate so as to overcome the biasing device, thereby moving the magazine away from the inlet port when the second burst disc is being moved into the flow path.

The apparatus may further comprise: an outlet port fluidly coupled to atmosphere or a fluid reclamation unit, the magazine being sealingly coupled to the outlet port.

It is thus possible to provide a burst disc replacement apparatus that obviates the need for a service engineer to attend the superconducting magnet unit very shortly after and every time a burst disc ruptures. Consequently, the maintenance cost associated with the superconducting magnet unit is reduced and running time of a system employing the superconducting magnet unit, for example a magnetic resonance imaging system, is extended, because use of the superconducting magnet unit does not have to stop pending arrival of the service engineer. Furthermore, it is possible to provide an apparatus that minimises exposure of the cryogen vessel to atmosphere and hence minimises icing-up of parts of the cryogen vessel and/or parts coupled thereto.

At least one embodiment of the invention will now be described, by way of example only, with reference to the accompanying drawings, in which:

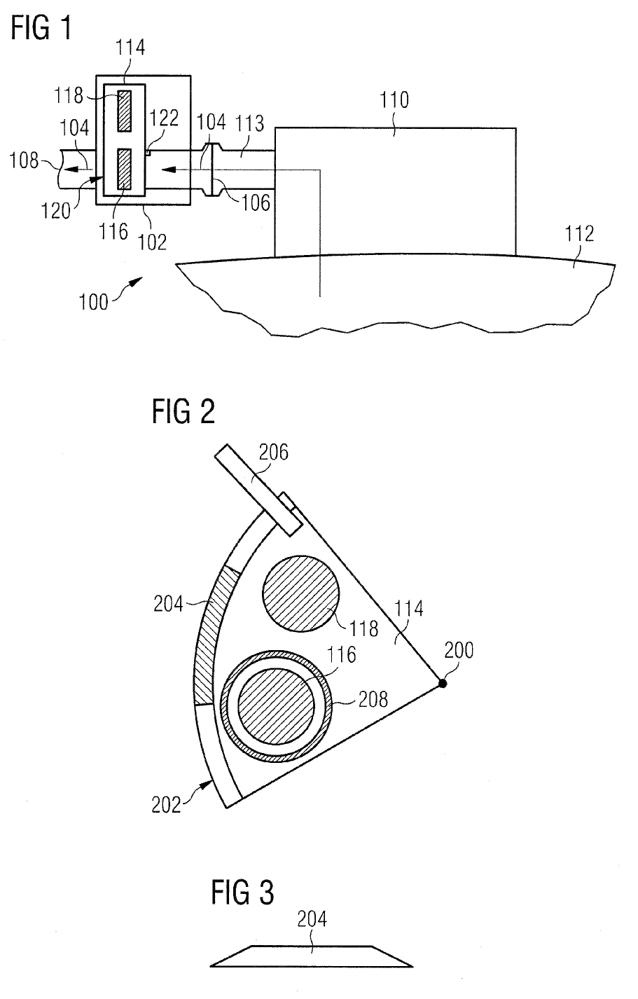

FIG. 1 is a schematic diagram of an apparatus constituting an embodiment of the invention coupled to a superconducting magnet unit;

FIG. 2 is a schematic diagram of a magazine used in the embodiment of FIG. 1;

FIG. 3 is a side elevation of a part of the magazine of FIG. 2;

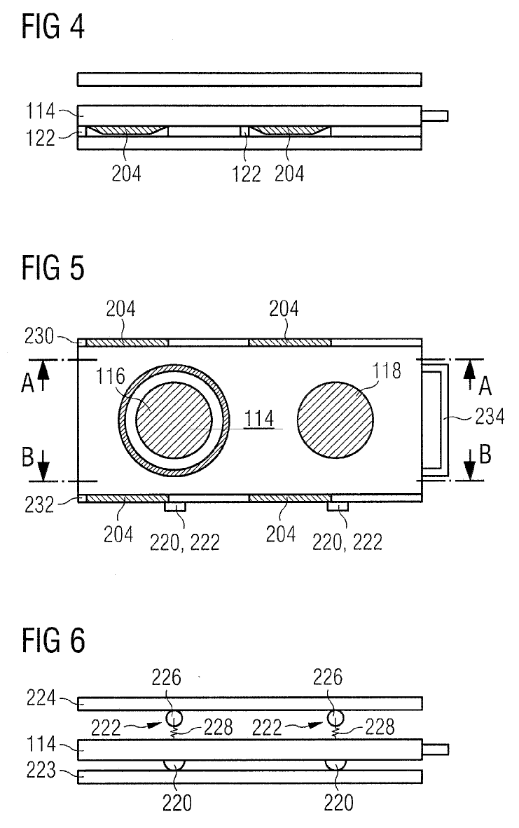

FIG. 4 is a horizontal section along the line A-A of FIG. 5; and

FIG. 5 is a schematic diagram of another magazine constituting an alternative embodiment of the invention;

FIG. 6 is a horizontal section along the line B-B of FIG. 4.

Throughout the following description identical reference numerals will be used to identify like parts.

Referring to FIG. 1, a burst disc replacement apparatus 100 comprises a burst disc changer 102 having a flow path 104 therethrough, the flow path 104 providing fluid communication between an inlet port 106 and an outlet port 108. The inlet port 106 is coupled to an access turret 110 of a vessel of a superconductive magnet unit 112 via a main vent conduit 113. The outlet port 108 is fluidly coupled via a funnel (not shown) to atmosphere. However, the skilled person should appreciate that the outlet port 108 can be coupled to a cryogen reclamation unit (also not shown). The superconducting magnet unit 112 is, in this example, part of an imaging system, such as a Magnetic Resonance Imaging (MRI) system, and comprises, inter alia, a cryogen vessel (not shown) containing a superconducting magnet (also not shown) located therein. The cryogen vessel is filled with a cryogen, for example liquid helium.

The burst disc changer 102 comprises a translation mechanism that includes a magazine 114 carrying a first burst disc 116 and a second burst disc 118. The magazine 114, in general, constitutes a carrier for burst discs, the carrier being capable of receiving burst discs and comprising a suitable mechanism for retaining the burst discs therein whilst allowing replacement of at least one of the burst discs. The magazine 114 is, in this example, substantially sector-shaped and rotatably mounted at a pivot point 200 (FIG. 2), the pivot point 200 of the magazine 114 being located so that an arc described by the centres of the first and second burst discs 116, 118 passes through a centre of the flow path 104. A biasing device (not shown), for example a spring, is disposed about the pivot point 200. The magazine 114 is coupled to the outlet port 108 by a retractable biased bridging conduit (not shown) to provide a part of the flow path 104. The biased bridging conduit is slidably coupled at a first end thereof to the outlet port 108 by a dynamic O-ring seal (not shown), but urged towards the magazine 114. A first O-ring seal is provided at a second end of the bridging conduit, the first O-ring seal abutting a rear face 120 of the magazine 114.

A periphery 202 of the magazine 114 comprises a sloped circumferential surface formation that extends substantially perpendicularly to a plane of the magazine 114. In this respect, the surface formation is a ramped length 204 disposed in-between the first and second burst discs 116, 118. In this example, the ramped length 204 rises from the plane of the magazine 114 close to where a notional radial line that passes through a centre of the first burst disc 116 intersects the periphery 202, and descends close to (and prior to) where a notional radial line that passes through a centre of the second burst disc 118 intersects the periphery 202. Once the ramp length 204 has risen to a maximum height, the ramp drops back to be level with the surface of the magazine 114 after a predetermined distance between the radial points. A corresponding follower 122 is provided on an internal surface of the burst disc changer 102 opposite the periphery 202 of the magazine 114. The profile of the ramp length 204 is shown in FIG. 3.

A lever 206 is attached to the magazine 114 to enable mechanical advantage to be used to translate the magazine 114.

The inlet port 106 has a peripheral sealing lip (not shown) and each burst disc 116,118 has a peripheral O-ring seal 208 (only shown in FIG. 2).

A burst detection sensor (not shown) associated with the first burst disc 116 is coupled to a control system (not shown).

Also, a pressure sensor in the access turret 110 is used to sense a pressure, sometimes known as a “quench pressure”, within the cryogen vessel. The pressure sensor is also coupled to the control system.

In operation, the magazine 114 is initially in a first position and the first burst disc 116 is in the flow path 104, the O-ring seal 208 being sealingly urged against the inlet port 106 by the biasing device.

In the event that the superconducting material, from which the superconducting magnet within the cryogen vessel is made, quenches, a quantity of the cryogen becomes heated and changes phase, for example enters a gaseous phase and is vented via the access turret 110 as, in this example, helium gas.

Referring back to FIG. 1, the helium gas travels along the main vent conduit 113 and builds up adjacent the first burst disc 116 disposed in the flow path 104. Once the pressure in the main vent conduit 113 (and hence adjacent the first burst disc 116) exceeds a predetermined rated pressure associated with a point of rupture of the first burst disc 116, the first burst disc 116 ruptures and the helium gas is vented safely to atmosphere via the outlet port 108 and the funnel or to the cryogen recovery system (not shown).

Rupture of the first burst disc 116 is sensed by the burst detection sensor and so the control system generates an alert to a user of an imaging system comprising the superconductive magnet unit 112 to inform the user that the first burst disc has been ruptured. The elevated pressure in the cryogen vessel that caused the rupture is also detected by the pressure sensor, the pressure in the cryogen vessel being too high for safe use of the superconductive magnet. Consequently, the control system therefore powers-down a compressor of the superconductive magnet unit 112 and issues an alert to the user that notifies the user of the excessively high pressure. Additionally, as the superconductive magnet has quenched, the superconductive magnet is destabilised and a magnetic field is no longer generated by the superconductive magnet. The user therefore waits until the pressure has reduced and the pressure alert is cancelled, it then being safe to replace the ruptured first burst disc 116.

Once the quench pressure has reduced to a safe level, the user or other personnel can operate the lever 206 in order to pivot the magazine 114 about the pivot point 200. As the lever 206 is pulled, the magazine 114 translates, following an arcuate path. As the magazine 114 translates, the follower 122 cooperates with the ramped length 204 and causes the ramped surface 204 to ride over the follower 122 urging the magazine 114 axially away from the inlet port 106, thereby overcoming the force of the biasing device and hence breaking the seal between the O-ring seal 208 of the first burst disc 116 and the peripheral sealing lip of the inlet port 106.

The magazine 114 then continues to translate at a maximum axial distance dictated by the interaction between the follower 122 and the highest portion of the ramped length 204. The first burst disc 116 therefore moves out of the flow path 104 and continues to move away from the flow path. At the same time, the second burst disc 118 approaches the flow path 104, the follower 122 reaching a slope of the ramped length 204 that descends in this direction of translation. The magazine 114 is therefore urged by the biasing device back towards the inlet port 106 so that the O-ring seal 208 of the second burst disc 118 is brought into sealing engagement with the peripheral sealing lip of the inlet port 106 as the second burst disc 118 becomes axially aligned and moves into registry with the inlet port 106. Hence, the second burst disc 118 is moved into place in the flow path 104 without fouling the O-ring seal of the second burst disc 118.

The magazine 114 has now therefore indexed one position and has replaced the first ruptured burst disc 116 with the second burst disc 118, fully sealed and intact, so that the imaging system is ready to continue operation. The process of indexing the magazine 114 and hence replacement of the ruptured first burst disc 116 has been completed without any intervention from a service engineer. Of course, the service engineer needs to be called to replace the ruptured first burst disc 116, but the presence of the service engineer is not required immediately and, during the interim period, the imaging system can still be used as a fully-sealed replacement burst disc is in place.

In another embodiment (FIGS. 4 and 5), the magazine 114 comprises the first burst disc 116 and the second burst disc 118. However, the magazine 114 is substantially rectangular in shape and is part of a translation mechanism that enables the magazine 114 to reciprocate following a substantially straight line between a first position and a second position. In this respect, an upper track and a lower track are provided along which the magazine can translate.

The magazine 114 comprises an upper set of lateral runners and a lower set of lateral runners. For clarity, only the lower set of lateral runners 220, 222 are shown in FIG. 5. Referring to FIG. 6, the lower set of lateral runners comprises a fixed pair of lateral runners 220 on a first side of the magazine 114 and a biased pair of lateral runners 222 on a second side of the magazine 114. The fixed pair of lateral runners 220 is urged against a first side 223 of the lower track 224 by the biased pair of lateral runners 222. In this respect, the biased pair of lateral runners 222 comprises a pair of runners 226 coupled to the magazine 114 by a respective pair of biasing devices 228.

The above structure is also provided in respect of the upper track of the translation mechanism.

In this example, one side of the magazine 114, opposite to the side on which the biased pair of lateral runners 220 is located, comprises an upper edge strip 230 and a lower edge strip 232, each of the upper and lower edge strips 230, 232 carrying a respective pair of spaced ramped lengths 204. Upper and lower parts of an internal surface of the translation mechanism also each carry a respective pair of spaced followers 122. The magazine 114 also carries a handle 234 for user actuation.

In this example, once the quench pressure has reduced to a safe level, the user or other personnel can operate the handle 234 in order to translate the magazine 114 in a substantially straight line, for example by pushing the magazine 114. As the handle 234 is pushed, the magazine 114 translates, following the substantially straight path, the followers 122 cooperating with the respective opposite ramped lengths 204, thereby causing the ramped surfaces 204 to ride over the followers 112 and urging the magazine 114 axially away from the inlet port 106. The magazine 114 therefore overcomes the force of the biasing devices 228 of the runners and hence breaking the seal between the O-ring seal 208 of the first burst disc 116 and the peripheral sealing lip of the inlet port 106.

The magazine 114 then continues to translate at a maximum axial distance dictated by the interaction between the followers 122 and the highest portions of the ramped lengths 204. The first burst disc 116 therefore moves out of the flow path 104 and continues to move away from the flow path. At the same time, the second burst disc 118 approaches the flow path 104, the followers 122 reaching respective slopes of the ramped lengths 204 that descend in this direction of translation. The magazine 114 is therefore urged by the biasing devices 228 of the biased lateral runners 222 back towards the inlet port 106 so that the O-ring seal 208 of the second burst disc 118 is brought into sealing engagement with the peripheral sealing lip of the inlet port 106 as the second burst disc 118 becomes axially aligned and moves into registry with the inlet port 106. Hence, the second burst disc 118 is moved into place in the flow path 104 without fouling the O-ring seal of the second burst disc 118.

The magazine 114 has now therefore indexed one position and has replaced the first ruptured burst disc 116 with the second burst disc 118, fully sealed and intact, so that the imaging system is ready to continue operation.

Although the above example has been described in the context of a horizontal implementation, the skilled person should appreciate that other orientations of the translation mechanism and magazine 114 are possible, for example a vertical orientation.

It should be appreciated that although the above examples have been described in the context of a first burst disc 116 and a second burst disc 118, the magazine 114 can be provided with one or more additional burst discs and a greater number of ramped lengths can be provided in an analogous manner to that described above.

If desired, the above embodiments can be provided with end stops to limit translation of the magazine 114 and/or prevent misalignment of the burst discs with the flow path 104.

Although the above-described technique for indexing the magazine 114 is a purely mechanical implementation, the skilled person should appreciate that the magazine 122 can be made to rotate using an electrical motor, a hydraulic device, a pneumatic device or any other suitable powered drive implementation.

Whilst the above embodiment has been described in the context of helium being used as the cryogen of choice, the skilled person should appreciate that helium is not mandatory and other cryogens can be employed. Also, whilst the above embodiment has been described in the context of an MRI system, the embodiment can be employed in relation to any suitable tomography system.

1. A burst disc replacement apparatus comprising:
a magazine carrying a first burst disc and a second burst disc;
a flow path therethrough for venting fluid, the first burst disc being located in the flow path and the second burst disc being located outside the flow path; and
a translation mechanism coupled to the magazine and arranged to permit translation of the magazine so that the second burst disc moves, when in use, into the flow path in place of the first burst disc.

2. An apparatus as claimed in claim 1, wherein the magazine is arranged to carry a plurality of burst discs including the first burst disc and the second burst disc.

3. An apparatus as claimed in claim 1, wherein the magazine is pivotally mounted.

4. An apparatus as claimed in claim 1, wherein the magazine is arranged to translate linearly.

5. An apparatus as claimed in claim 1, wherein the first burst disc and the second burst disc follow an arcuate translation path.

6. An apparatus as claimed in claim 1, wherein the magazine is arranged to translate so as to follow a substantially straight line.

7. An apparatus as claimed in claim 1, wherein the magazine is arranged to reciprocate at least between a first position and a second position.

8. An apparatus as claimed in claim 1, further comprising a mechanical stop for prevention of misalignment of the second burst disc with the flow path.

9. An apparatus as claimed in claim 1, wherein the magazine defines a substantially sector-shaped planar carrier.

10. An apparatus as claimed in claim 1, wherein the magazine defines a substantially rectangular-shaped carrier.

11. An apparatus as claimed in claim 9, wherein the carrier is arranged to receive a replacement burst disc in place of the first burst disc or the second burst disc.

12. An apparatus as claimed in claim 1, further comprising:
an inlet port disposed on one side of the magazine; and
a biasing device arranged to urge the magazine towards the inlet port.

13. An apparatus as claimed in claim 12, further comprising: a first surface and a second surface arranged to cooperate so as to overcome the biasing device, thereby moving the magazine away from the inlet port when the second burst disc is being moved into the flow path.

14. An apparatus as claimed in claim 1, further comprising:
an outlet port fluidly coupled to atmosphere or a fluid reclamation unit, the magazine being sealingly coupled to the outlet port.

15. An apparatus according to claim 1 wherein the translation mechanism is arranged to permit manual translation of the magazine.

16. A magnetic resonance imaging system comprising the burst disc replacement apparatus as claimed in claim 1.

17. A burst disc replacement apparatus substantially as hereinbefore described with reference to the accompanying drawings.
